(19) United States
(12) Patent Application Publication
(10) Pub. No.: US 2026/0216925 A1
(43) Pub. Date: Jul. 30, 2026

(54) INJECTION MOLDING SYSTEM AND USE OF SUCH SYSTEM TO PRODUCE A DEVICE FOR BEING POSITIONED WITHIN THE EAR CANAL OF A USER

(71) Applicant: EARFAB APS, Dronningmølle (DK)

(72) Inventors: Søren ANDERSEN, Varde (DK); Jesper Winther ANDERSEN, Dronningmølle (DK)

(21) Appl. No.: 19/147,303

(22) PCT Filed: Jan. 10, 2024
(86) PCT No.: PCT/EP2024/050483

§ 371 Date: Jul. 10, 2025

(30) Foreign Application Priority Data
Jan. 10, 2023 (DK) PA202300020

(51) Int. Cl. B29C 33/00; B29C 33/38; B29C 33/40; B29C 45/34; B29C 45/44; B29K 21/00; B29L 31/34; B33Y 80/00

(52) U.S. Cl. CPC B29C 33/0022; B29C 33/3842; B29C 33/40; B29C 45/34; B29C 45/4457; B33Y 80/00; B29K 2021/00; B29K 2905/00; B29K 2995/007; B29L 2031/3431

(57) ABSTRACT

The present invention relates to an injection molding system for the production of a device for being positioned within the ear canal of a user.

### TECHNICAL FIELD OF THE INVENTION

The present invention relates to the field of earpiece production.

### BACKGROUND OF THE INVENTION

Custom fit earpieces are commonly used in industries that include earplug production, hearing protection, hearing aid manufacture, assisted listening device manufacture, and headphone products. However, it has not been economically feasible to mass produce custom fit earpieces for a single user.

Generally, the current process for making elastomeric custom shaped earpieces is via a silicone mold cast from a negative mold. The silicone mold is prepared by first creating a positive representation of the final object. The positive representation has been created from the final shape, which has either been manually sculpted from a silicone ear impression, or electronically sculpted by a rapid prototyping machine from a scanned ear impression or a direct scan. A negative mold is then casted from the positive representation. The negative mold is typically cast with an elastomeric material. When the negative mold material has solidified, the positive representation is removed from the negative mold. In preparation for molding, a mold release agent is added to the mold surface to prevent the elastomeric material from sticking thereto. Before the elastomeric material is introduced into the negative mold, objects may be inserted into the negative mold to e.g., create air vents therein. The negative mold is then manually filled with an elastomeric material to reform the positive shape in the elastomeric material. After the elastomeric material has solidified the positive piece is removed. As is obvious from this description, there are disadvantages, especially in terms of manual labour, but also in terms of precisely positioning the air vents.

### OBJECT OF THE INVENTION

The objective of the present invention is to provide a system and process for the mass production of custom fit earpieces, such as an earplug for a single user.

### DESCRIPTION OF THE INVENTION

A first aspect of the present invention relates to an injection molding system for the production of a device for being positioned within the ear canal of a user, the system comprising:
an outer mold comprising a plurality of parts which together form a first cavity, said parts preferably made of metal; and
an inner mold adapted for being positioned with said first cavity and having walls forming a second cavity, said cavity being defined by the shape of said device, said inner mold preferably being made of a polymeric material, such as a thermoplastic material and/or a 3D-printable resin;
   wherein the outer mold comprises a first injection gate leading into said first cavity, wherein the inner mold comprises a second injection gate leading into said second cavity, and wherein said first and second gates are aligned such that an injection molding material may be introduced into said second cavity via said first and second gates.

A second aspect of the present invention relates to an injection molding system for the production of a device, the system comprising:
an outer mold comprising a plurality of parts which together form a first cavity, said parts preferably made of metal; and
an inner mold adapted for being positioned with said first cavity and having walls forming a second cavity, said cavity being defined by the shape of said device, said inner mold preferably being made of a polymeric material, such as a thermoplastic material and/or a 3D-printable resin;
   wherein the outer mold comprises a first injection gate leading into said first cavity, wherein the inner mold comprises a second injection gate leading into said second cavity, and wherein said first and second gates are aligned such that an injection molding material may be introduced into said second cavity via said first and second gates.

Injection molding is a formative manufacturing technology, i.e., the product is formed from an amorphous shape into a fixed shape defined by a molding tool. The product is created by two or more tools moving together to form a closed volume into which a polymer, often a thermoplastic polymer, is injected under pressure. In a two-part tool the cavity is formed in one of the tool parts and creates the quality outer surfaces of the product, and a core is formed in the other tool part and creates inner details of the product.

The novel approach of the present invention is to place an insert, i.e., the inner mold, into the cavity of the traditional mold, i.e., the outer mold. Hence, the first cavity in the outer mold is defined by the shape of the inner mold and not by the shape of the product. The outer mold is similar to a traditional injection molding tool but is primarily present to stabilize and support the inner mold during the injection molding operation. The amorphous material is not injected directly into the first cavity but rather into the second cavity of the inner mold, positioned within the first cavity of the outer mold. Thus, preferably, the outer mold is made of a material adapted for this purpose, such as metal, e.g., aluminum or steel. The advantage of this construct is that the inner mold can be shaped in a relatively less strong material, such as thermoplastic polymers or 3D printed materials, that does not need to be processed and shaped by for example a CNC machine as is the case with traditional injection molds. Traditional molds may be suitable to produce thousands of products, but in the present case, a user may only need a few custom fit products during a lifetime, why it is not economically feasible to use traditional injection molds.

In one or more embodiments, the inner mold is produced by additive manufacturing, such as fused deposition modeling (FDM), stereolithography (SLA), or digital light processing (DLP) e.g., based on information, such as an image, about the shape of a user's ear canal. The ear canal may e.g., be imaged by scanning with any suitable scanning technique including standard camera and video techniques. Standard camera and video techniques may include two-dimensional images and three-dimensional images. The image may be processed into a file ready for additive manufacturing, e.g., using specially developed software, or any of the commercially available CAD/CAM design software packages, such as eShell by Geomagic, RSM by Materialize, or 3Shape ShellManager by 3Shape. Such software may import the object and shape the object into the form the final output object will take. This software may also be used to add, subtract, and/or reshape aspects of the object. Non-limiting examples of added objects may e.g., be injection gate(s), cavities for electronic equipment, and air vent(s). The inventors of the present invention have also constructed new types of mold-specific objects, such as support objects, cavity positioning objects, handle objects, objects for creating a splitting zone, and objects for creating air vents in the splitting zone. Such objects may be added by Boolean operations in the software. Finally, the amended object is saved as a file (e.g., a stereolithography (STL) file format, or an additive manufacturing file (AMF, 3MF) format) for the additive manufacturing apparatus to read and process.

In one or more embodiments, the inner mold is a single-piece mold. The term “single-piece” is to be understood as the mold being made as one unit that cannot be disassembled into a plurality of pieces without breaking the mold. The single-piece mold is preferably produced by additive manufacturing.

Preferably, the inner mold is adapted for single use. In a preferred embodiment, the inner mold is adapted for being broken into two or more pieces. In one or more embodiments, the inner mold comprises a splitting zone adapted for rupturing when said inner mold is twisted and/or when a tool is inserted into said splitting zone. This embodiment allows the inner mold to be broken into two or more pieces, preferably into two pieces if only one splitting zone is present. In the present context, the term “splitting zone” is to be understood as a zone/area of the inner mold that is relatively weaker (brakes easier) than other areas/zones of the inner mold. The splitting zone(s) preferably extends from the outside of the inner mold and towards the second cavity. The splitting zone(s) preferably extends along the circumference of the inner mold. In one or more embodiments, the splitting zone extends obliquely from one side of the inner mold to an opposite side of the inner mold and relative to a central axis extending along the length of said inner mold. This configuration allows for an easier production of the inner mold by additive manufacturing, such as fused deposition modeling (FDM), stereolithography (SLA), or digital light processing (DLP). One way of producing a splitting zone may be by removing material from the walls of the inner mold, e.g., by introducing cavities or channels into the walls, or by making the walls thinner in the splitting zone compared to other zones of the inner mold. In one or more embodiments, the splitting zone comprises a plurality of spaced apart columns, preferably extending along the length of said inner mold. In one or more embodiments, the splitting zone comprises one or more cavities adapted for receiving a tool (e.g., a screwdriver or a key), and wherein at least a part of said splitting zone is adapted for rupturing when said tool is operated, e.g., twisted, within said one or more cavities. The splitting zone may also have other functionalities, such as a venting zone with one or more venting slots. The venting slots are in air communication with the second cavity such that air may escape therefrom during the filling operation. In one or more embodiments, the splitting zone comprises one or more venting slots. To prevent the escaping air from being blocked by the outer mold, the inner mold may be provided with cavities or slots formed in the outside of the inner mold. In one or more embodiments, the inner mold comprises venting slots and wherein said venting slots open into cavities and/or slots formed in the outside of the inner mold. Alternatively, or in combination, air vents may also be present in the outer mold. The inner mold may be conically shaped. This configuration allows for an easier production of the inner mold by additive manufacturing, such as fused deposition modeling (FDM), stereolithography (SLA), or digital light processing (DLP), but also allows the outer mold to provide a better support thereto.

As an alternative to a splitting zone, or in combination with a splitting zone, the inner mold may be adapted for dissolving in a solvent, preferably water, e.g., a basic aqueous solution, such as a sodium hydroxide aqueous solution. Suitable materials for additive manufacturing are developed for dissolving in water, e.g., a basic aqueous solution, such as a sodium hydroxide aqueous solution, such as e.g., resins comprising polyvinyl alcohol.

Preferably, the inner mold is produced for custom fit for an individual user.

A third aspect relates to the use of an injection molding system according to the present invention for the production of a device for being positioned within the ear canal of a user.

In one or more embodiments, the injection molding material for filling the second cavity comprises one or more elastomers, such as curable elastomers or thermoplastic elastomers.

Some thermoplastic elastomers may be divided into four classes: polyolefin elastomers, thermoplastic polyurethanes, thermoplastic polyester copolymers, and styrenic block copolymers. The polyolefin elastomers possess the lowest density of all the thermoplastic elastomers. DuPont's Engage® is an example of an olefin, which is available in clear and colored grades. Polyurethanes are known for their excellent abrasion resistance. Polyester, polyether, and polycaprolactone based urethane grades work well with the plastic injection molding process. The polyester types exhibit better mechanical properties while the polyether types have improved low temperature properties and resistance to hydrolysis. The polycaprolactone group offers improved hydrolysis resistance compared to the polyester-based urethanes while offering similar mechanical properties. Polyester copolymers provide flexibility and fatigue strength over a broad temperature range. DuPont's Hytrel® is an example of such an elastomer. Two types of Styrenic elastomers are generally available for plastic injection molding. The Styrene-Butadiene-Styrene (SBS) block and the Styrene-Ethylene/Butylene-Styrene (SEBS) block. Trade names for these materials include KRATON® D and KRATON® G respectively. The SEBS block elastomers have higher temperature resistance and can withstand prolonged outdoor exposure, while the SBS block is limited to indoor applications. Both types are resistant to water, acids, and bases. A preferred thermoplastic elastomer (TPE) may e.g., be a transparent medical TPE (e.g., Mediprene 500M series™), or oil-free TPE (e.g., Mediprene™ OF400M, OF600M, OF800M), Mediprene™, or Mediprene™ OF500M).

Elastomers, such as rubbers, e.g., silicone, neoprene rubber, nitrile rubber, and EPDM, may also be used as the injection molding material for filling the second cavity, but should be cured in the second mold prior to removal therefrom.

The injection molding material may also comprise other components, such as curing agents, colorants, and fillers.

In one or more embodiments, the injection molding material for filling the second cavity consists essentially of one or more elastomers.

In one or more embodiments, the injection molding material for filling the second cavity has a shore A hardness at room temperature within the range of 10-70, preferably within the range of 15-60, and more preferably within the range of 20-50.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows a perspective view of an inner mold according to the present invention.

FIG. 2 shows a perspective and transparent view of an inner mold according to the present invention, where the second cavity is enhanced as a grid.

FIG. 3 shows a cross-sectional view of an inner mold according to the present invention.

FIG. 4 shows a perspective view of an object for creating a splitting zone according to the present invention.

FIG. 5 shows a perspective view of an outer mold according to the present invention.

References

| | |
|---|---|
| 100 | Outer mold |
| 102 | First outer mold part |
| 104 | Second outer mold part |
| 110 | First cavity |
| 120 | First injection gate |
| 200 | Inner mold |
| 210 | Second cavity |
| 220 | Second injection gate |
| 230 | Splitting zone |
| 232 | Column |
| 234 | Cavity |
| 236 | Venting slot |
| 240 | Venting slot |
| 250 | Cavity |
| 260 | Venting slot |
| 270 | Gasket |
| 300 | Center axis |

### DETAILED DESCRIPTION OF THE INVENTION

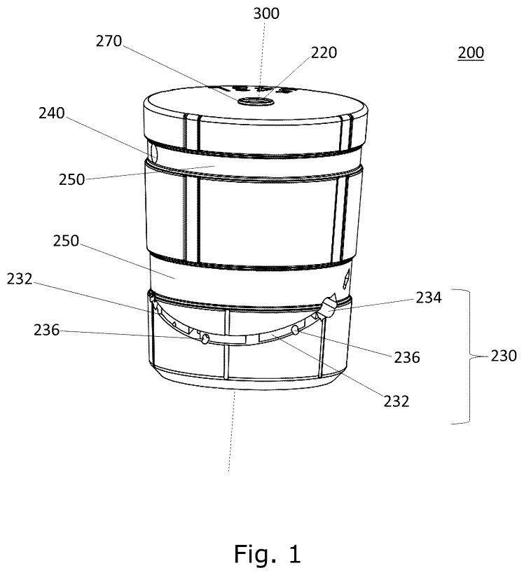

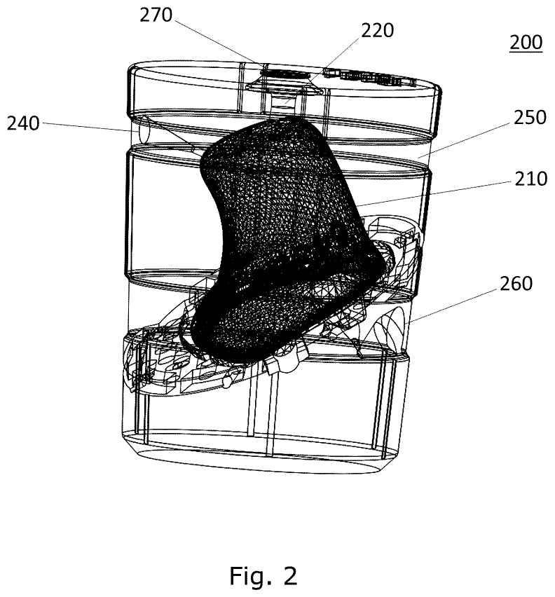

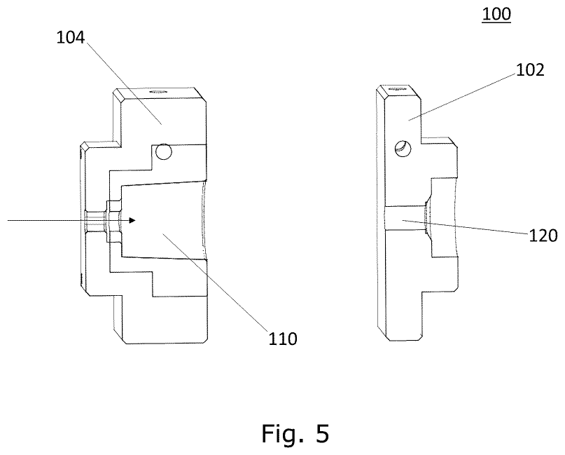

The following description is exemplary embodiments of inner 200 and outer 100 molds according to the present invention and is not intended to be limiting for the scope of the invention. FIGS. 1 and 2 show an inner mold 200 according to the present invention. The inner mold 200 is shaped and adapted for being positioned with a first conically shaped cavity 120 of the outer mold 100 disclosed in FIG. 5. Still referring to FIG. 5, the outer mold 100 is shown as a two-part tool, where the majority of the first cavity 120 is formed in one tool part 104, and the other tool part 102 functions as a lid with a first injection port 120 leading into the first cavity 120.

The novel approach of the present invention is to place the inner mold 200 into the first cavity 120 of the outer mold 100. Here, the first cavity 120 in the outer mold 100 is defined by the shape of the inner mold 200 and not by the shape of the product (device) as is the case with traditional injection molding tools. Once the inner mold 200 has been filled with the injection molding material it can be removed by an ejector tool (not shown, but normally present in the channel where the arrow is positioned) pushing it out in a movement as indicated by the shown arrow. The two tool parts 102, 104 may be provided with channels for cooling fluids to rapidly cool the injection molding material present in the second cavity 210 of the inner mold 200. Referring again to FIGS. 1 and 2, the inner mold 200 is manufactured by additive manufacturing, more specifically by stereolithography based on information about the shape of a user's ear canal. The inner mold 200 comprises a second injection gate 220 leading into the second cavity 210. The first 120 and second 220 gates are aligned such that an injection molding material may be introduced into the second cavity 210 via both the first 120 and the second 220 injection gates.

The inner mold 200 is a single-piece mold that must be broken to allow the molded device to be removed therefrom and is shown comprising a splitting zone 230 adapted for rupturing when the inner mold 200 is twisted or when a tool is inserted into the splitting zone 230. The splitting zone 230 comprises a plurality of cavities 234 adapted for receiving a tool. The splitting zone 230 is adapted for rupturing when the tool is operated, e.g., twisted, within these cavities 234. To further make the splitting zone weaker than the remaining part of the inner mold 200, the splitting zone 230 comprises a plurality of spaced apart columns 232 that extend along the length of the inner mold 200. Furthermore, a plurality of venting slots 236 are also positioned/formed within the splitting zone 230, whereby even less material is present therein. Obviously, the venting slots 236 are also positioned there to let air escape from the second cavity 210 during filling thereof with injection molding material. Venting slots 240, 260 are also placed in other parts of the inner mold. In general, the number and position of venting slots depend on the complexity of the second cavity, i.e., the device to be molded.

The splitting zone 230 is here shown extending obliquely from one side to an opposite side of the inner mold 200 and relative to a central axis 300 extending along the length of the inner mold 200.

The the inner mold 200 is here also shown with a gasket positioned around the opening of the injection gate 220. The gasket is present to provide a seal between the tool part 102 and the injection gate 220 to avoid leakage of injection molding material.

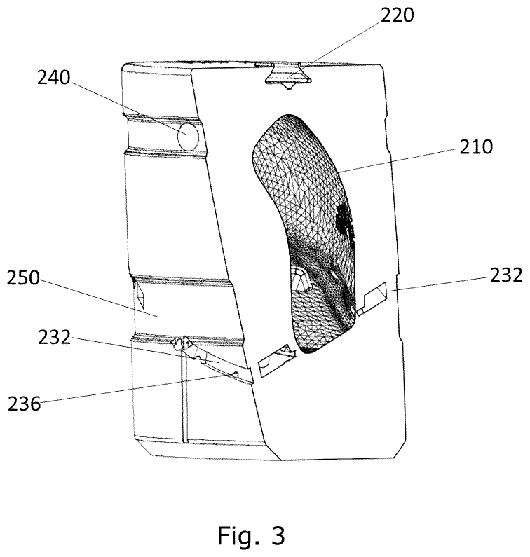

FIG. 3 shows a cross-sectional view of an inner mold 200 according to the present invention.

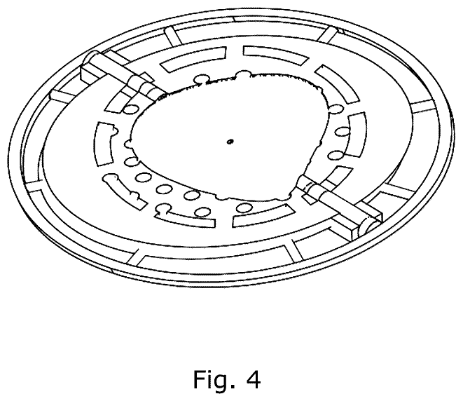

As previously said, software may be used to add, subtract, and/or reshape aspects of the second mold to be prepared by additive manufacturing. Non-limiting examples of added objects may e.g., be injection gate(s), cavities for electronic equipment, and air vent(s). The inventors of the present invention have also constructed new types of mold-specific objects. FIG. 4 shows a perspective view of such an added object for creating a splitting zone in the inner mold, i.e., the splitting zone object is subtracted from the original shape of the inner mold.

1. An injection molding system for the production of a device, the system comprising:
an outer mold (100) comprising a plurality of parts (102, 104), which together form a first cavity (110), said parts (102, 104) preferably made of metal; and
an inner mold (200) adapted for being positioned with said first cavity (110) and having walls forming a second cavity (210), said cavity (210) being defined by the shape of said device, said inner mold (200) preferably being made of a polymeric material;
wherein the outer mold (100) comprises a first injection gate (120) leading into said first cavity (110), wherein the inner mold (200) comprises a second injection gate (220) leading into said second cavity (210), and wherein said first (120) and second (220) gates are aligned such that an injection molding material may be introduced into said second cavity (210) via said first (120) and second (220) gates.

2. The injection molding system according to claim 1, wherein said inner mold (200) is produced by additive manufacturing based on information, such as an image, about the shape of a user's ear canal.

3. The injection molding system according to claim 1, wherein said inner mold (200) is adapted for being broken into two or more pieces.

4. The injection molding system according to claim 1, wherein said inner mold (200) is a single-piece mold.

5. The injection molding system according to claim 3, wherein said inner mold (200) comprises a splitting zone (230) adapted for rupturing when said inner mold (200) is twisted or when a tool is inserted into said splitting zone (230).

6. The injection molding system according to claim 5, wherein said splitting zone (230) extends obliquely from one side of said inner mold (200) to an opposite side of said inner mold (200) and relative to a central axis extending along the length of said inner mold (200).

7. The injection molding system according to claim 5, wherein said splitting zone (230) comprises a plurality of spaced apart columns (232), preferably extending along the length of said inner mold (200).

8. The injection molding system according to claim 5, wherein said splitting zone (230) comprises one or more cavities (234) adapted for receiving a tool, and wherein at least a part of said splitting zone (230) is adapted for rupturing when said tool is operated, e.g., twisted, within said one or more cavities (234).

9. The injection molding system according to claim 5, wherein said splitting zone (230) comprises one or more venting slots (236).

10. The injection molding system according to claim 2, wherein said inner mold (200) is produced for custom fit for an individual user.

11. The injection molding system according to claim 1, wherein said inner mold (200) is adapted for dissolving in a solvent.

12. The injection molding system according to claim 1, wherein said inner mold (200) is conically shaped.

13. The injection molding system according to claim 1, wherein said inner mold (200) comprises venting slots (240) and wherein said venting slots (240) open into cavities (250) formed in the outside of the inner mold (200).

14. Use of an injection molding system according to claim 1 for the production of a device for being positioned within the ear canal of a user.

15. The use according to claim 14, wherein the injection molding material for filling the second cavity (220) comprises one or more elastomers.

16. The use according to claim 14, wherein the injection molding material for filling the second cavity (220) has a shore A hardness at room temperature within the range of 10-70.
